(19) United States
(12) Patent Application Publication
(10) Pub. No.: US 2009/0262663 A1
(43) Pub. Date: Oct. 22, 2009

(54) Wireless Discovery of Devices

(75) Inventors: Philip Gosset, Stroud (GB); Richard Harper, Cambridge (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/105,773

(22) Filed: Apr. 18, 2008

(51) Int. Cl. H04L 12/28; G06F 17/30; H04L 29/02

(52) U.S. Cl. 370/254; 707/3; 370/345; 707/E17.014

(57) ABSTRACT

A method for wireless discovery of devices is described. In an embodiment, a Wireless Personal Area Networking (WPAN) device advertises its presence to other WPAN devices by transmitting a beacon which includes its identity. The beacon may include a header and/or footer. This message is picked up by other WPAN devices in proximity to the transmitting device and these receiving devices store data identifying the transmitting device. In some embodiments, a database of beacons received by WPAN devices is maintained. This database may be used to associate data which is relevant to transmitting WPAN devices (or to a user thereof) with a WPAN identity.

### BACKGROUND

Wireless communication between electronic devices is known. There are a number of technologies for providing Wireless Personal Area Networking (WPAN). For example, Bluetooth® is a technology specification that facilitates wireless communication between devices such as cell phones, personal digital assistants, handheld computers, laptops, computers and peripherals and the like. It allows the transmission of voice and data signals over short distances (typically up to around 10 meters, depending on the hardware used), over a radio link. In order to send a signal from one device to another, and thereby establish an ad hoc network, Bluetooth® enabled devices have a Device Discovery Mode. In that mode, each device periodically transmits an inquiry beacon and then monitors the Bluetooth® frequency range for a response. Any Bluetooth® enabled device may respond to the inquiry message, sending back its Bluetooth® address, its class information (i.e. whether it is a mobile phone, personal digital assistant, etc) and some associated synchronization information, such as clock data. Other WPAN devices have similar methods for establishing an ad-hoc network.

Devices alternate between transmitting inquiry messages and scanning for a response (or responses) to their own inquiry message. The Bluetooth® specification provides a recommended time for the duration of the process of sending a message and receiving a response as 10.24 seconds. Bluetooth® also allows for the production of a pairing arrangement or an ad-hoc network. However, such a procedure may be too long for real time dynamic situations for example when two users of WPAN devices walk past one another thus inhibiting ‘lightweight’ user behaviors where pairing is not sought, and places demands on device battery life.

The embodiments described below are not limited to implementations which solve any and all disadvantages of known Bluetooth® or other WPAN devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method for wireless discovery of devices is described. In an embodiment, a Wireless Personal Area Networking (WPAN) device advertises its presence to other WPAN devices by transmitting a beacon which includes its identity. The beacon may include a header and/or footer. This beacon is picked up by other WPAN devices in proximity to the transmitting device and these receiving devices store data identifying the transmitting device. In some embodiments, a database of beacons received by WPAN devices is maintained. This database may be used to associate data which is relevant to transmitting WPAN devices (or to a user thereof) with a WPAN identity.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of Bluetooth® enabled devices;

FIG. 2 is a flow diagram of a known means of discovering neighboring Bluetooth® devices;

FIG. 3 is a schematic diagram of an interactive notice board and a Bluetooth® enabled cell phone;

FIG. 4 is a schematic representation of a beacon data packet;

FIG. 5 is a flow diagram showing interaction between the devices shown in FIG. 3;

FIG. 6 is a schematic diagram of an image capture;

FIG. 7 is a flow diagram of an example method of operation of an image capture device;

FIG. 8 is a schematic diagram showing a sequence of events relating to image capture devices;

FIG. 9 shows a schematic diagram of an example of a computing device;

FIG. 10 is a flow diagram of an example method of operation of a computing device such as shown in FIG. 9; and

FIGS. 11 and 12 illustrate exemplary computing-based devices in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the examples and the sequence of steps for constructing and operating the examples. However, the same or equivalent functions and sequences may be accomplished by different examples.

Wireless Personal Area Network (WPAN) enabled devices commonly include mobile phones, personal digital assistants (PDAs), computers, peripheral devices for computers (such as keyboards, speakers and the like), telephone headsets, digital cameras and the like. WPAN enabled devices are capable of forming ad-hoc networks when they are brought within range of one another.

Bluetooth® is an example of a WPAN technology. There are three classes of Bluetooth® devices, Class 1 which operates at a power of around 100 mW and has a range of about 100 meters, Class 2, which operates at 2.5 mW and has a range of about 10 meters and Class 3 which operates at 1 mW and has a range of about 1 meter. This disclosure describes examples of class 2 devices, but is applicable to other classes of device.

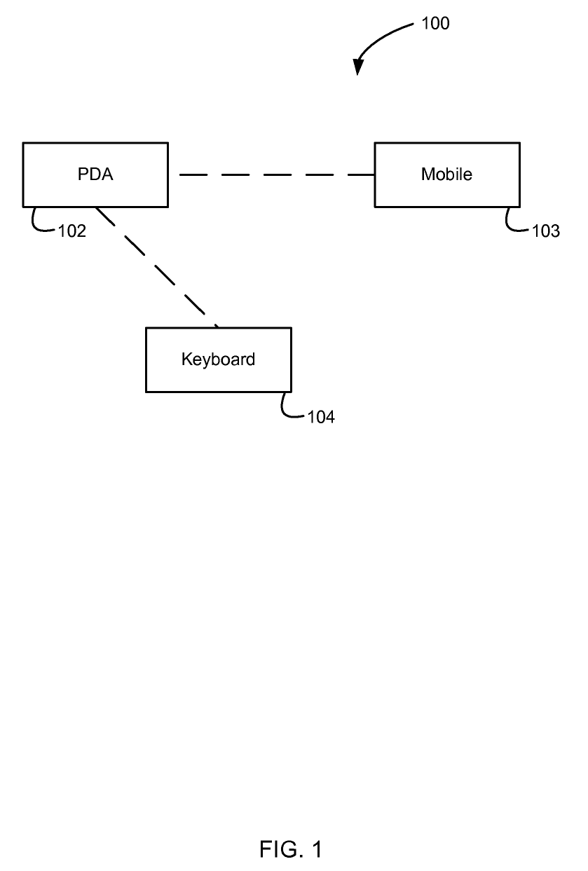

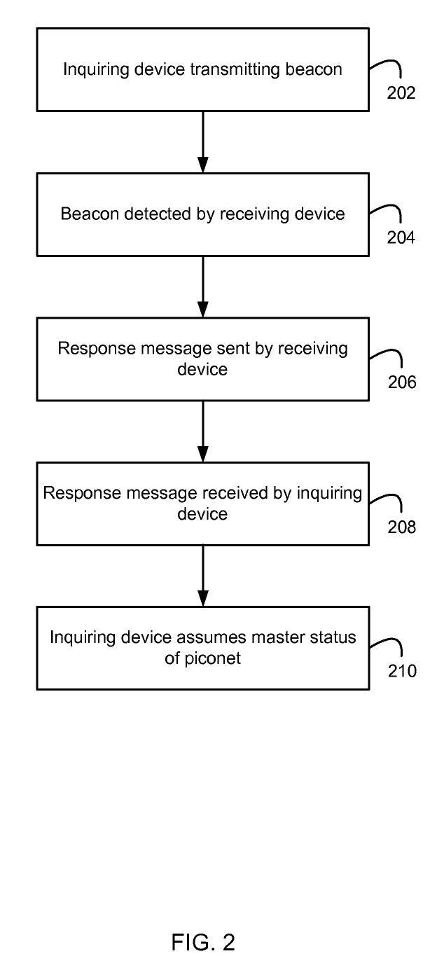

FIG. 1 shows an example ad-hoc Bluetooth® network 100, which is usually termed a ‘piconet’ by those skilled in the art. In this example, the network is formed of a PDA 102, a keyboard 104 and a mobile phone 103. The known method of establishing connections between these devices 102, 104, 103 is now discussed with reference to the flow diagram of FIG. 2.

The devices 102, 104, 103 operate differently depending on the device type. While the keyboard 104 is passive and remains in a scanning state, the mobile phone 106 and the PDA 102 alternate between an inquiry phase and a scanning phase. Whilst in the inquiry phase, the devices 102, 103 use a Frequency Hopping Spread Spectrum (FHSS) method with a hopping rate of 1,600 hops per second. The frequency band for Bluetooth® is (in the US and much of Europe) 2,400-2,483.5 MHz, which is divided into 79 radio frequency channels. The FHSS method results in the channel being divided into time slots, each being 625 μs, with a different frequency being associated with each slot. An inquiring device transmits beacons at pseudo-random points within the inquiry phase (block 202). The beacons consist of a channel access code, which identifies the channel on which the beacon was sent. This beacon is detected by another Bluetooth® enabled device 102, 104, 106 (block 204) within 10 meters. This receiving device sends a response message on the frequency of the beacon according to the Bluetooth® protocol (block 206), the response message comprising a Bluetooth® identity for the device sending the response, some clocking information to allow synchronization and information concerning the responding device and its class. The response message also contains a message header and may contain a footer. This message is then received by the inquiring device (block 208). On receipt of the header, the device which sent the inquiry message will start listening for the expected response message.

The inquiring device then assumes the role of ‘master’ and the responding device assumes the role of ‘slave’ in the piconet (block 210). The master defines a piconet physical channel over which the devices will communicate and takes control of the traffic on this channel. There can be up to seven slaves in a piconet.

The term ‘beacon’ as used herein means a message which is sent at a time determined by the sending device and not, for example, in response to a received inquiry message.

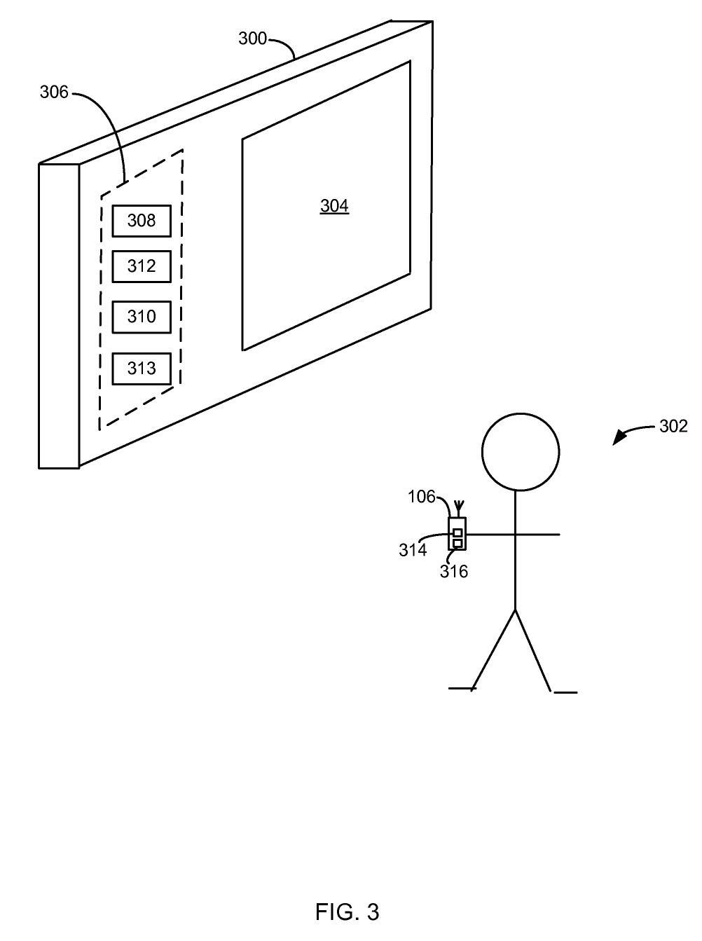

FIG. 3 shows a schematic representation of an interactive notice board 300 and a user 302 with a Bluetooth® enabled mobile phone 106. The notice board 300 comprises a screen 304 arranged to display information to the user 302 and processing circuitry 306. The processing circuitry 306 comprises a memory 308, which is arranged to store a database of Bluetooth® identities associated with preference information and to store display information which can be displayed on the screen 304. The processing circuitry 306 further comprises a receiver circuit 310, capable of receiving Bluetooth® data packets, a processing unit 312 capable of processing data and a display driver 313, capable of controlling the display of the screen 304.

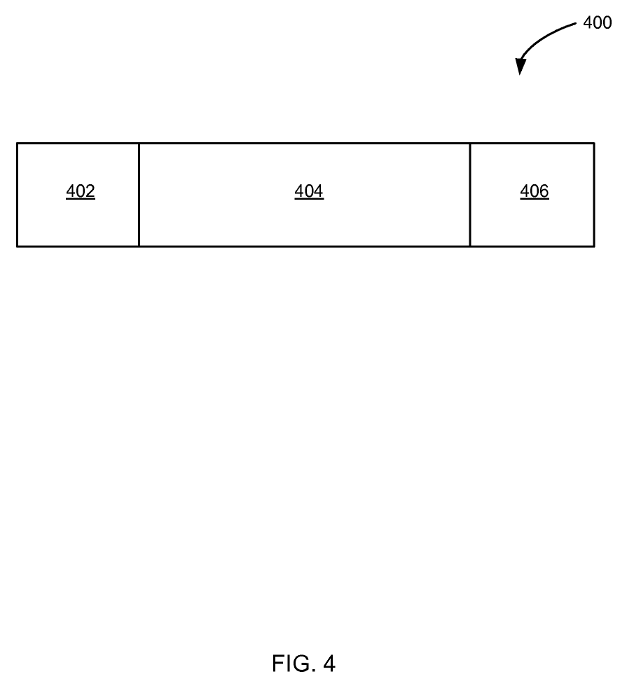

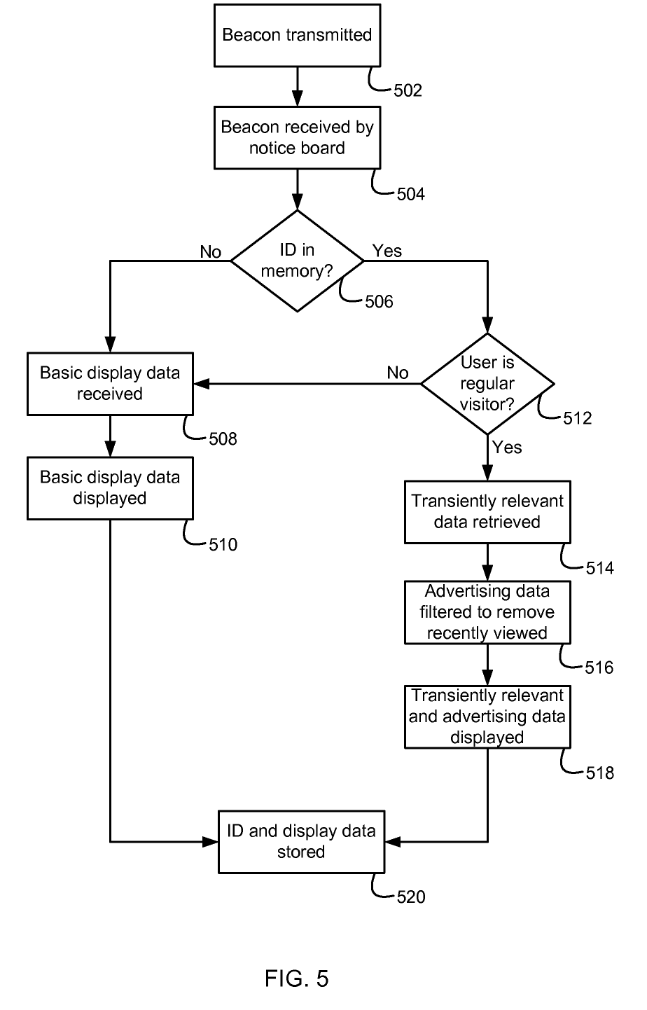

The mobile phone 106 comprises a Bluetooth® transceiver unit 314 and a processing unit 316 capable of controlling the transceiver unit 314 to transmit beacons and is now discussed in relation to FIGS. 4 and 5.

The transceiver unit 314 of the mobile phone 106 is controlled by the processing unit 316 to emit an advertising beacon 400 at a number of random positions during its 2.56 second communication cycle, which is shown schematically in FIG. 4. This advertising beacon 400 comprises a header 402, the unique Bluetooth® Identification (ID) 404 and a footer 406. In this example, the advertising beacon 400 is approximately 64 bits, of which the ID 404 takes up 48 bits. In this example, the mobile phone 106 is placed in a discoverable mode in order to transmit beacons. This allows a user to choose whether or not the identity of his or her phone 106 is discoverable by third parties.

This beacon 400 will be transmitted in full in approximately 0.1 ms. As this is relatively short (when compared to the response message discussed above), sending the beacon 400 is not a drain on the resources of the mobile phone 106, in particular on the battery resources of the mobile phone 106 (or other WPAN devices). In addition, the brevity of the transmission of the beacon 400 means that it is unlikely to collide with beacons or transmissions sent from other devices which may be close to the notice board 300. In addition, the brevity means that a number of beacon messages can be sent in a given cycle which further reduces the likelihood of collisions. The advertising beacon 400 is sent at random (or pseudo-random) times in a further effort to avoid collisions.

The receiver circuit 310 of the interactive notice board 300 listens for advertising beacons 400. The interaction between the notice board 300 and the mobile phone 106 is now described with reference to the flowchart of FIG. 5.

In this example, the user 302 has placed the mobile phone 106 into its discoverable mode. As a result, the transceiver unit 314 of his or her mobile phone 106 periodically emits an advertising beacon 400 (block 502). As the user 302 walks past the interactive notice board 300, one of these beacons 400 is received by the receiver circuit 310 of the notice board 300 (block 504). The processing unit 312 reads the ID 404 from the beacon 400 and searches to see if there is a record relating to that ID 404 in its memory 308 (block 506) by querying the database held therein.

If there is no record, then the processing unit 312 retrieves basic display data (block 508), in this example a map of the area, from the memory 310 and controls the display driver 313, which in turn controls the screen 304, to display the data (block 510).

If there is a record associated with that ID 400, then the processing unit 312 considers the preference information associated therewith. In this example, the preference information depends on how often the user's mobile phone 106 (and therefore, it can be assumed, the user 302) has passed by. If the mobile phone 106 passes by more than 3 times a week (block 512), it is assumed that the user 300 is a regular visitor who knows the area and therefore does not need to see a map. Instead, the processing unit 312 retrieves transiently relevant data, in this case weather display data, from the memory 310 (block 514).

In this example, the display 304 also displays advertising to regular visitors. The adverting shown is chosen from a selection of advertising material and this selection is filtered to exclude advertising shown to that user 300 on the previous ten occasions on which he or she passed by the notice board 300 (block 516). The processing unit 312 then controls the display driver 313, which in turn controls the screen 304, to display the weather data and the advertising data (block 518).

In either case, the ID 404 is stored along with the time at which it was detected and the data displayed on the screen 304 in the memory 508 (block 518).

Although this example advertising beacon 400 comprises a footer 406, in other examples, there may not be a footer 406. In addition, the communication cycle may be longer than or shorter than the example of 2.56 second given. The content of the data, i.e. the map data, weather data and advertisement data is provided purely for example and any other form of data could be used. The preference data may include previously indicated preferences of the user 300, or may be linked to the Bluetooth® enabled device that is being carried, for example, advertising games which can be played on that model of mobile phone 106, or products which are associated with a predetermined demographic also associated with that mobile phone 106. Of course, the mobile phone could be replaced by any appropriate WPAN device which emits beacons 400. The ID 404 need not be a Bluetooth® ID.

The interactive notice board 300 may comprise a screen of a vending machine selling goods, tickets or the like. The previous choices of a user could be stored in the memory and these or related items could be presented to a user as a ‘first choice’. For example, if the vending machine sells train tickets, the user could be presented with a choice of destinations to which they have traveled previously and may also be presented with information about that route, such as delays or impending changes to the time table.

Changing a notice board 300 is only one example of an environmental factor that could be controlled. In other examples, the user's environment could be altered in other ways than displaying information on a notice board 300. For example, a user could enter a room and find, on detection of a beacon 400 from his or her PDA 102, the lighting, temperature, volume levels or other environmental factors in that room are reset to his or her preferred settings as stored in a database which can be used to control the environment. Many other examples will occur to skilled person.

It will be noted that there is no attempt to set up a communication network such as a piconet. This means that there is no limitation on the number of devices which can interact with the notice board 300.

In a second example embodiment, images captured in geographical proximity can be shared to show a viewer more than one set of images captured at a particular event, e.g. a sporting event, music concert, holiday destination (e.g. a ski resort) and gain a better (e.g. more detailed) impression or record of such an event.

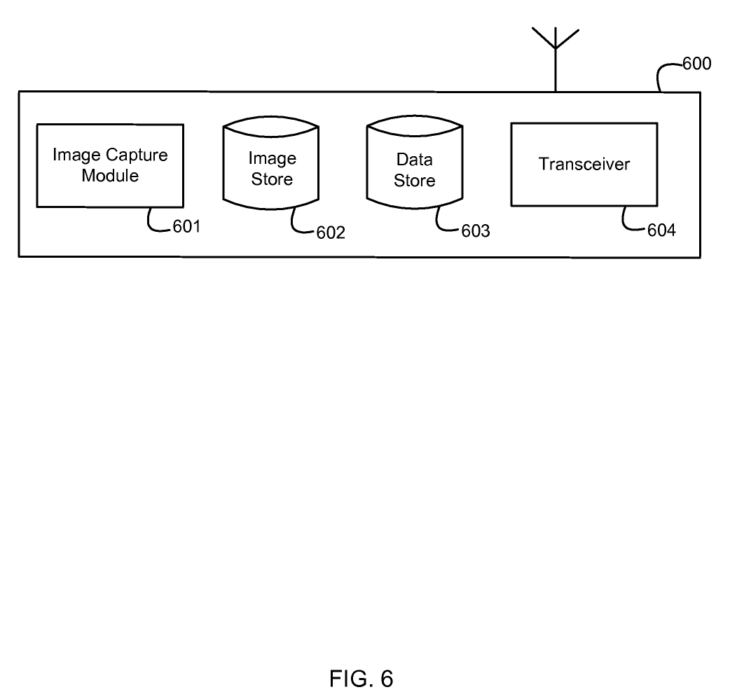

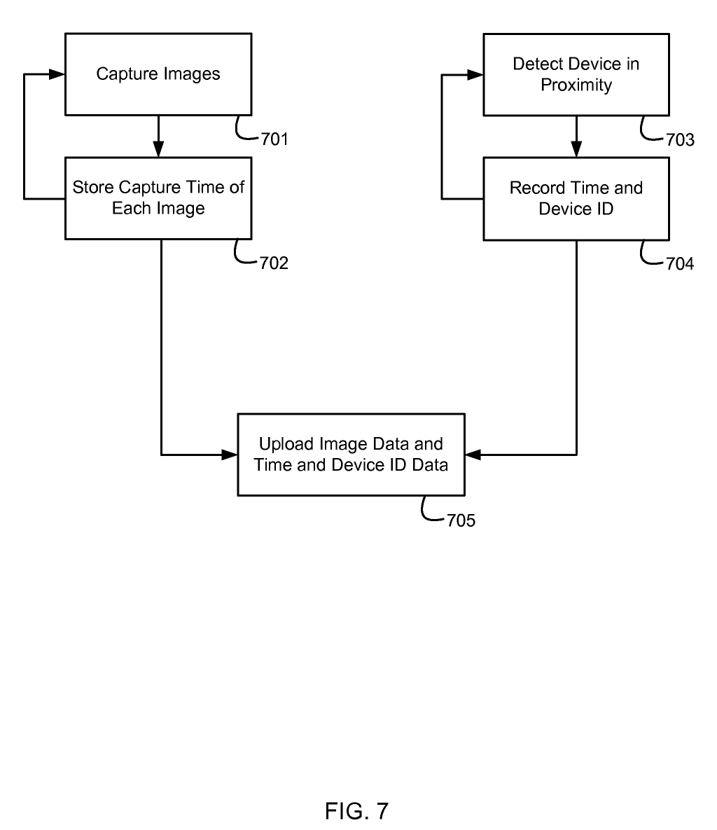

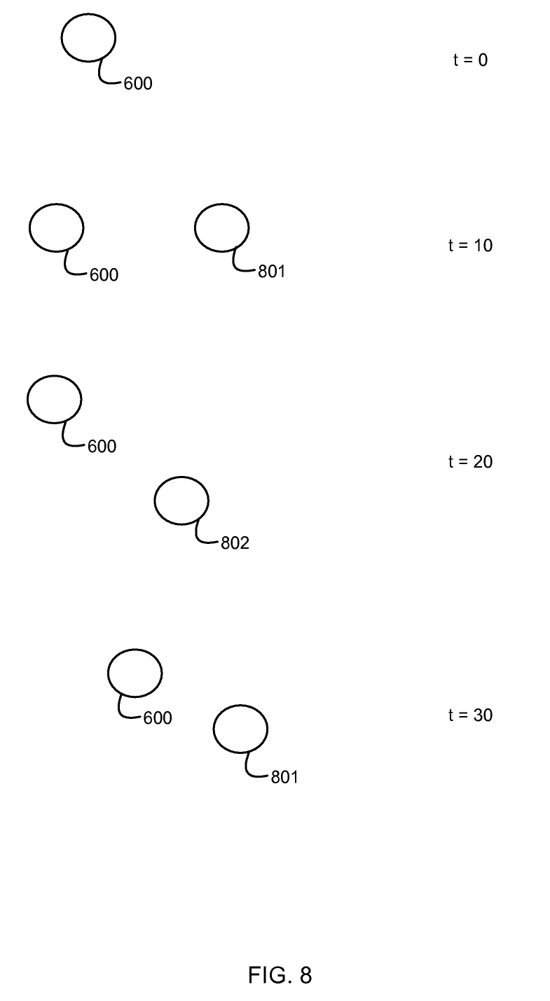

FIG. 6 is a schematic diagram of an image capture device 600 which comprises an image capture module 601, an image store 602, a data store 603 and a transceiver 604. The operation of the image capture device 600 can be described with reference to FIGS. 7 and 8. FIG. 7 is a flow diagram of an example method of operation of an image capture device, such as that shown in FIG. 6. FIG. 8 is a schematic diagram showing a sequence of events relating to image capture device 600.

The image capture device 600 may be a digital camera, a wearable camera (e.g. SenseCam®), a mobile telephone, a personal digital assistant (PDA) or any other device which is capable of capturing images, the time of capture and data to enable determination of devices which are in proximity. The image capture device may be a dedicated device or may be a device running an application in order to operate as described herein.

The image capture device 600 captures images (block 701) using the image capture module 601. These images may be still images or video clips and may be captured automatically or may be captured as a result of user input. Where the images are captured automatically, image capture may be triggered based on elapsed time, sensor data or any other trigger parameter. The capture time for each captured image is stored (block 702) in metadata associated with the image. The captured images and any associated metadata may be stored in the image store 602. Alternatively, the capture time data may be stored separately in the data store 603. One or more images may be captured and stored.

The image capture device 600 in this example is in a discoverable mode, and therefore transmits beacons. In addition, the image capture device 600 is placed in a discovery mode, such that it detects other devices in proximity to the image capture device (block 703). The image capture device 600 alternates between a transmission interval in which it transmits beacons 400 and a listening interval, in which it listens for beacons 400 from other devices.

The device detection may use any WPAN or short range communication technology and utilizes the transceiver 604. Each time a beacon 400 is received, a record corresponding to ID 404 for the detected device is updated (block 704) and this data is updated in the data store 603. The record in this example comprises Bluetooth® ID, the time at which a beacon was first detected for that device, and the last time that a beacon was last detected as a ‘record triplet’, such as (BZ id, start_time, end_time). If (or while) only one beacon is detected, the end-time is the same as the start-time. In other examples, the time at which each beacon 400 is received may be stored.

FIG. 8 shows a simple sequence of events relating to an image capture device 600. Initially there are no other devices in proximity to the first image capture device 600 (at t=0). Subsequently, the first device 600 detects a beacon sent by a second device 801 (as in block 703) and the time of detection and device ID 404 for this second device are recorded (as in block 704), e.g. t=10, device=801. Some time later, a beacon from a third device 802 is detected by the first device 600 (as in block 703) and the time and ID 404 are stored (as in block 704), e.g. t=20, device=802. Some time later still, a second beacon 400 is recieved from the second device 801 and the time and ID 404 are stored, e.g. t=30, device=801.

Subsequently the captured image data and the time and device ID data may be uploaded to another device, such as a web server (block 705). The captured image data which is uploaded may comprise the images themselves or links to where the images are stored. The data (e.g. captured image, device ID and time data) may be uploaded directly from the image capture device 600 to a web server (or other entity), which may be remote, or may be uploaded via another entity, such as a local PC. The operation of the web server or other entity to which the image data and associated data are uploaded is described in more detail below.

The detection of devices in proximity (in block 705) may be performed using any WPAN or short range communication technology. For example, the transceiver 604 may comprise a Bluetooth® transceiver. In another example, IrDA, WiFi or ZigBee may be used and therefore the transceiver 604 may comprise an IrDA, WiFi or ZigBee transceiver respectively. In the WiFi example, the identifier may be the MAC address of the WiFi device or a device name.

Each of the devices may perform device detection and store the related data (as in blocks 703-706) or alternatively only a subset of the devices may perform device detection and store the related data (as in blocks 703-706). Those devices not performing device detection may still capture images (blocks 701-702) and, as long as they send beacons 400, their images may, in some examples, still be associated with other sets of images based on the data stored by the subset of devices. In another example, a separate device, which may not be an image capture device, may detect proximate devices and upload data to the central entity (such as computing device 1200 described below) to enable it to link sequences of images captured by other devices. For example, a receiver (e.g. a WiFi access point) may be located at a particular event to store beacons 400 received from image capture devices at the event. This data may be subsequently used to associate images captured at the event.

Whilst FIG. 6 shows a transceiver 604, it will be appreciated that in some examples the image capture device 600 may comprise a transmitter and a receiver or may comprise only a receiver to detect a beacon 400 or only a transmitter to send a beacon 400.

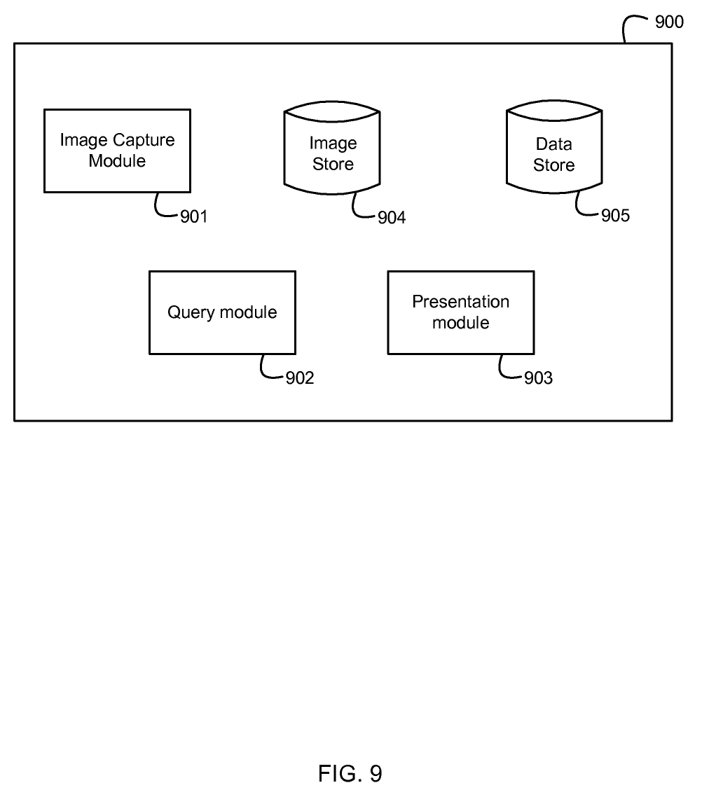

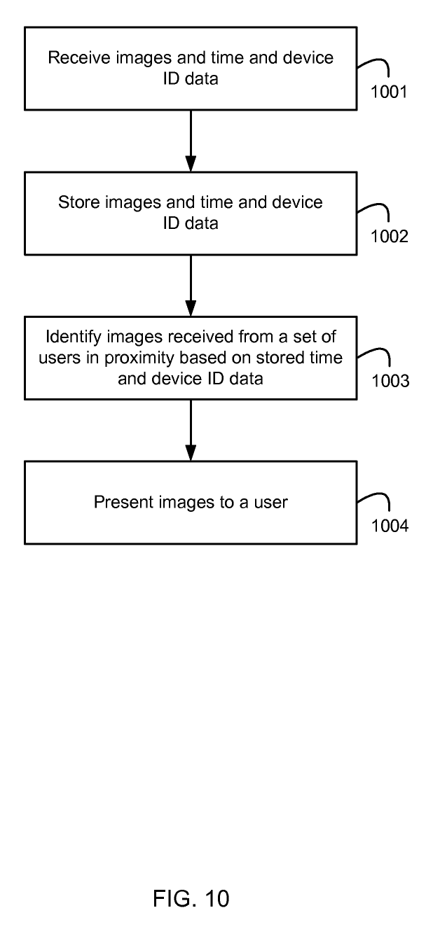

As described above, the images captured and data stored by an image capture device 600 may be uploaded to computing device (in block 705), such as a web server. FIG. 9 shows a schematic diagram of an example of such a computing device 900 and an example of its method of operation can be described with reference to the flow diagram shown in FIG. 10. The computing device 900 comprises a communication interface 901, a query module 902, a presentation module 903, an image store 904 and a data store 905.

In this example, plurality of users upload data onto the computing device 900. This may be, for example, a number of fans who attended a football game or musical event uploading images onto a fan website, or a number of people who attended a social event uploading images onto a social networking website.

From each image capture device 600, 801, 802, the computing device 900 receives (i) image data, which in this example includes the time at which the image was captured, (ii) the ID 404 of the image capture device 600, 801, 802 and (iii) the time and ID data stored in the data store 603 on receipt of a beacon 400 (block 1001). The image data may comprise the images themselves (e.g. the image files) or may comprise information identifying where the images are stored (e.g. a URL, IP address, file path, link etc) and the images may comprise still images or video clips. The data is received (in block 1001) via the communications interface 901 and then stored (block 1002) in the image store 904 and the data store 905 (which may in some embodiments be a combined store).

A user can then query the image store 904 to access image data provided by image capture devices 600, 801, 802 which were at some time in proximity to the user's own image capture device. In this example, the user is able to search for images taken by other devices 600, 801, 802 for one minute either side of the first and last beacons 400 detected from this device 600, 801, 802. This allows a user to access images which will supplement their memory of the event. The stored data is used to identify these images which were captured whilst in proximity to each other (block 1003) using the query module 902. The identified images (from block 1003) can then be presented to a user (block 1004).

As described above, the image data and associated data may be uploaded directly from the image capture device to the computing device 900 (e.g. using a wired or wireless link) or alternatively, the images and data may first be uploaded to a first computing device (such as the user's PC) and then uploaded from that first computing device to a computing device 900 which performs a method such as that shown in FIG. 10. The uploading may involve transferring the image data and associated data across a network, such as the internet.

The query process (block 1003) may retrieve images uploaded by any image capture device to the computing device 900 or alternatively the image capture devices may be arranged in groups identified by their IDs 404 and only those images uploaded by an image capture device within a particular group may be retrieved. For example, family groups or groups of friends may be defined such that images captured by any member of the family group or the friends group may be linked but these images cannot be linked with images captured by third parties. An image capture device may belong to more than one group.

Where the image data uploaded (in blocks 707) comprises video clips, rather than still images, the video clips may be segmented according to the devices in proximity and linked in a corresponding manner to sequences of images. Image data of different types may be retrieved, e.g. video clips may be retrieved along with still images.

The presentation of the image data (in block 1004) may comprise generation of a web page or other form of graphical user interface which displays the plurality of retrieved images or may comprise sending each of the plurality of linked sequences to an email or URL address.

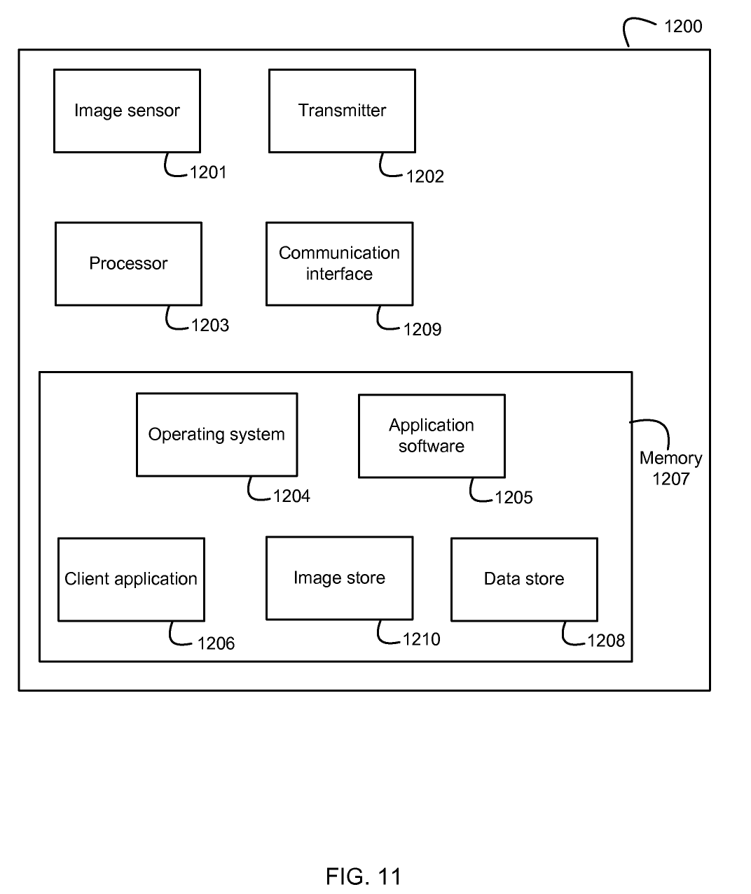

FIG. 11 illustrates various components of an exemplary computing-based device 1200 which may be implemented as any form of a computing and/or electronic device, and in which embodiments of the methods described above, and in particular the mobile phone 106, PDA 102 or image capture devices 600, 801, 802, may be implemented.

Computing-based device 1200 comprises an image sensor 1201 and a transmitter 1202 which uses a WPAN technology. The transmitter 1202 is arranged to send beacons 400. Alternatively, the transmitter 1202 may be replaced by a wireless transceiver or the device may optionally comprise a receiver, which may use a WPAN technology, such as Bluetooth®. The image sensor 1201 is optional in some examples although the person of skill in the art will appreciate that image sensors are now provided on a plurality of devices such as mobile phones, PDA and the like, and in many cases are a standard feature of these devices.

The computing-based device 1200 also comprises one or more processors 1203 which may be microprocessors, controllers or any other suitable type of processors for processing computing executable instructions to control the operation of the device in order to send beacons 400. The processor(s) 1203 may, in some examples, also capture beacon data, capture images or other data, capture associated data and upload the image data and associated data (as described above). Platform software comprising an operating system 1204 or any other suitable platform software may be provided at the computing-based device to enable application software 1205, 1206 to be executed on the device.

The application software comprises a client application 1206 comprising executable instructions arranged to cause the device to send beacons 400. The client application 1206 may also capture beacon data, capture images, capture associated data and upload the image and associated data.

The computer executable instructions may be provided using any computer-readable media, such as memory 1207. The memory is of any suitable type such as random access memory (RAM), a disk storage device of any type such as a magnetic or optical storage device, a hard disk drive, or a CD, DVD or other disc drive. Flash memory, EPROM or EEPROM may also be used. The memory 1207 may also be used for an image store 1210 and a data store 1208.

The computing-based device 1200 may further comprise a communication interface 1209 to allow the uploading of images and data to another device, or alternatively the transceiver 1202 may be used.

The computing-based device 1200 may also comprise one or more inputs which are of any suitable type for receiving media content, Internet Protocol (IP) input etc and one or more outputs, e.g. for providing an audio and/or video output to a display system integral with or in communication with the computing-based device. The display system may provide a graphical user interface, or other user interface of any suitable type.

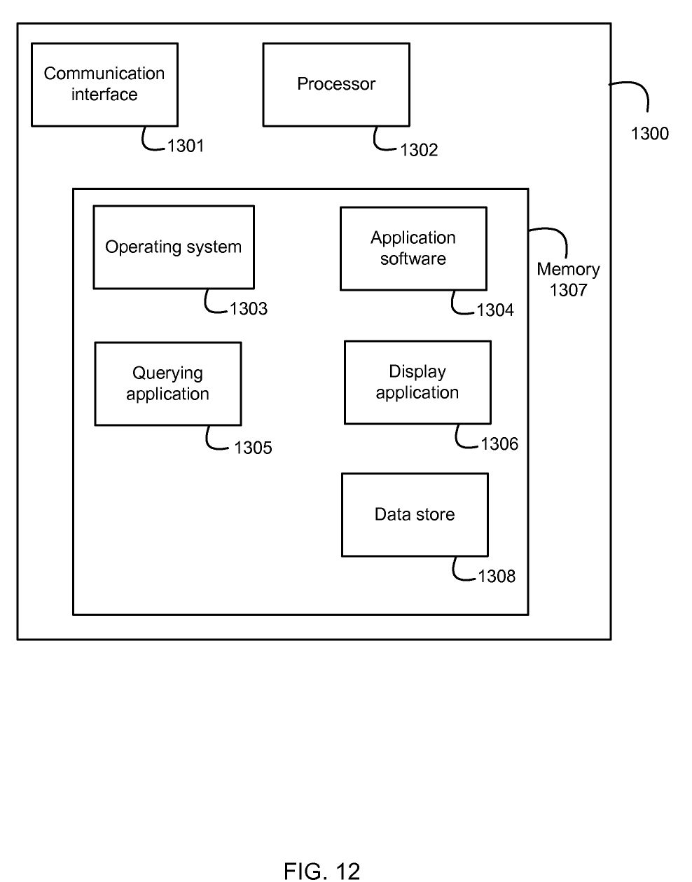

FIG. 12 illustrates various components of an exemplary computing-based device 1300 which may be implemented as any form of a computing and/or electronic device, and in which embodiments of the methods described above may be implemented. In particular the computing-based device 1300 may be arranged to query data based on received beacons 400.

The computing-based device 1300 comprises a communication interface 1301 for receiving data, which may be beacon data and/or image data, or may be data input from another source, such as in response to a questionnaire requesting a user's preferences. The computing-based device 1300 also comprises one or more processors 1302 which may be microprocessors, controllers or any other suitable type of processors for processing computing executable instructions to control the operation of the device in order to associate and present images or other data. Platform software comprising an operating system 1303 or any other suitable platform software may be provided at the computing-based device to enable application software 1304-1306 to be executed on the device. The application software comprises a querying application 1305, comprising executable instructions to cause the processor to search stored data to identify relevant related data and a control application 1306, comprising executable instructions to cause the processor to control a user's environment, e.g. to control the visual environment (present data as a result of the search to a user using a local or a remote display device) or to control other aspects of the environment, e.g. sound, temperature, or the like.

The computer executable instructions may be provided using any computer-readable media, such as memory 1307. The memory is of any suitable type such as random access memory (RAM), a disk storage device of any type such as a magnetic or optical storage device, a hard disk drive, or a CD, DVD or other disc drive. Flash memory, EPROM or EEPROM may also be used. The memory comprise comprises a data store 1309 (which in some embodiments described above comprises an image store).

The computing-based device 1300 may further comprise one or more inputs which are of any suitable type for receiving media content, Internet Protocol (IP) input etc and one or more outputs such as an audio and/or video output to a display system integral with or in communication with the computing-based device. The display system may provide a graphical user interface, or other user interface of any suitable type. The communication interface 1301 may be used to output the data for display to a user or to control external equipment such as audio equipment, lighting equipment, air conditioning equipment or alternatively a separate output may be provided.

Although the present examples are described and illustrated herein as being implemented in a web based system, the system described is provided as an example and not a limitation. As those skilled in the art will appreciate, the present examples are suitable for application in a variety of different types of computing systems.

The FIGS. showing apparatus comprise functional elements which may be combined in any way. Furthermore the devices may comprise additional elements not shown in the FIGS. And elements within the FIGS. may be combined to create further example devices. In some examples, different apparatus may perform the query and presentation method blocks or the method may be performed in a distributed manner across a number of devices.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants, digital cameras and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A WPAN device comprising a transmitter arranged to transmit data and a processor arranged to control the transmission of data, wherein the WPAN device is arranged to be placed in a discoverable mode and, when in the discoverable mode, to periodically transmit a beacon comprising a device identifier.

2. A device according to claim 1 wherein the beacon comprises less than 100 bits.

3. A device according to claim 1 wherein the beacon comprises approximately 64 bits.

4. A device according to claim 1 which is a Bluetooth® device.

5. A device according to claim 1 which comprises a receiver and which is further arranged to be placed in a discovery mode, in which the receiver scans for beacons sent from other devices.

6. A device according to claim 5 which comprises a memory, wherein the processor is arranged to store the identifier contained in any received beacon in the memory.

7. A device according to claim 6 in which the device comprises an output arranged to allow data stored thereon to be transferred to a computing device.

8. A device according to claim 1 which comprises a device which is carried by a user.

9. A computer comprising a WPAN receiver arranged to receive beacons comprising identity data identifying a device from which the beacon originated, a memory arranged to store the identity data in a database in association with further data, a query application arranged to query the database in order to retrieve data of relevance to a particular device identity, and a control application arranged to control at least one environmental factor according to the data retrieved.

10. A computer according to claim 9 which comprises a screen, wherein the control application is arranged to control the display of data on the screen.

11. A computer according to claim 9, which comprises a communication interface arranged to allow apparatus external to the computing device to be controlled.

12. A computer according to claim 9, in which the control application is arranged to control at least one environmental factor at a location which is local to the receiver.

13. A computer according to claim 9 in which the data retrieved comprises data associated with the device identity according to predetermined preferences of a user of the device.

14. A computer according to claim 9 in which the data retrieved comprises data associated with the device identity according to previous interactions between the device and the computer.

15. One or more device-readable media with device-executable instructions for performing steps comprising:
constructing a radio frequency WPAN beacon comprising a device identity;
sending the beacon at random or pseudo-random times within a transmission period.

16. One or more device-readable media with device-executable instructions for performing steps according to claim 15 in which the step of constructing the beacon comprises constructing a beacon which consists of a message header and a device identity.

17. One or more device-readable media with device-executable instructions for performing steps according to claim 15 in which the step of constructing the beacon comprises constructing a beacon which consists of a message header, a device identity and a message footer.

18. One or more device-readable media with device-executable instructions for performing steps according to claim 15 in which the step of constructing the beacon comprises constructing a beacon which comprises a Bluetooth® identity.

19. One or more device-readable media with device-executable instructions for performing steps according to claim 15 in which the step of constructing the beacon comprises constructing a beacon which can be sent in approximately 0.1 s.

20. One or more device-readable media with device-executable instructions for performing steps according to claim 15 in which the step of sending the beacon comprising sending the beacon at a frequency determined using Frequency Hopping Spread Spectrum (FHSS) methods.
